(19) United States
(12) Patent Application Publication
(10) Pub. No.: US 2019/0325477 A1
(43) Pub. Date: Oct. 24, 2019

(54) SYSTEMS AND METHODS FOR OPTIMIZING WEB TRAFFIC PERFORMANCE

(71) Applicant: RIWI Corp., Toronto (CA)

(72) Inventors: Neil Laurence Seeman, Toronto (CA); Alton Ing, Vancouver (CA)

(21) Appl. No.: 16/387,731

(22) Filed: Apr. 18, 2019

Related U.S. Application Data
(60) Provisional application No. 62/660,549, filed on Apr. 20, 2018.

(51) Int. Cl. G06Q 30/02; G06Q 30/08

(52) U.S. Cl. CPC G06Q 30/0248; G06Q 30/08; G06Q 30/0275; G06Q 30/0246

(57) ABSTRACT

Various embodiments are described herein for methods and systems that can be used for optimizing Web traffic performance. In at least one embodiment, there is provided a method for optimizing Web traffic performance, where a buyer system hosts one or more websites and purchases Web traffic from one or more source platforms via a network. The method comprises storing a predetermined blacklist threshold in a memory corresponding to the buyer system; receiving a plurality of Web traffic visitors from a plurality of source platforms at a user interface module corresponding to the buyer system; recording, in the memory, a number of Web traffic visitors received by the buyer system; for each source platform, determining, at a processor corresponding to the buyer system, a number of actions performed by at least some Web traffic visitors received from the corresponding source platform; for each successive visitor, determining, at the processor, a score based on the number of Web traffic visitors and the number of actions performed by at least some Web traffic visitors received from the corresponding source platform, the score being determined in real-time or batch mode; and for each successive visitor, if the determined score is greater than the predetermined blacklist threshold, accepting the corresponding successive visitor by the buyer system.

### CROSS-REFERENCE TO RELATED APPLICATIONS

This application claims priority from U.S. Provisional Application No. 62/660,549, which is incorporated herein by reference.

### FIELD

The embodiments described herein relate to systems and methods for optimizing Web traffic performance. In particular, the embodiments described herein relate to systems and methods for optimizing performance of Web traffic, including all types of traffic received from Web traffic bidding platforms, in real-time or batch mode.

### BACKGROUND

In the field of digital advertising, ad buyers purchase Internet traffic on automated bidding platforms in order to drive Web visitors to the buyers' websites. The total Web traffic received at the buyers' websites comes in different forms and thus may be variously referred to as “redirect traffic”, “direct navigation traffic”, “domain traffic”, “type-in traffic”, “pay per click (PPC) traffic”, “pop-up (POP) traffic”, “organic traffic”, “search traffic” or “social traffic”. Buyers of all these types of Web traffic often target specific demographics and Web visitor profiles, based on factors such as keywords, locations, devices, and user profiles, that will most effectively lead to buyer-defined desired actions by Web visitors, including actions such as clicks, views, purchases, product downloads, etc.

The originating source of traffic visitors is commonly obfuscated and unknown to the buyer because Web traffic may be coming from multiple traffic trading networks that are cascaded and aggregated to maximize profits for the traffic providers. Furthermore, the aggregated pool of Web traffic from multiple trading networks may contain mismatched demographics as well as fraudulent traffic sources for the buyer, resulting in underperforming Web traffic that does not yield any actions. Consequently, ad buyers may end up wasting millions of dollars on digital ad fraud, specifically, on Web traffic that does not deliver any value to the buyer. Accordingly, a dynamic system is needed to address such a Web traffic quality or digital ad fraud problem.

### SUMMARY

In one aspect, in at least one embodiment described herein, there is provided a method for optimizing Web traffic performance, where a buyer system hosts one or more websites and purchases Web traffic from one or more source platforms via a network. The method comprises storing a predetermined blacklist threshold in a memory corresponding to the buyer system; receiving a plurality of Web traffic visitors from a plurality of source platforms at a user interface module corresponding to the buyer system; recording, in the memory, a number of Web traffic visitors received by the buyer system; for each source platform, determining, at a processor corresponding to the buyer system, a number of actions performed by at least some Web traffic visitors received from the corresponding source platform; for each successive visitor, determining, at the processor, a score based on the number of Web traffic visitors and the number of actions performed by at least some Web traffic visitors received from the corresponding source platform, the score being determined in real-time or batch mode; and for each successive visitor, if the determined score is greater than the predetermined blacklist threshold, accepting the corresponding successive visitor by the buyer system.

In various embodiments, for each successive visitor, if the determined score is less than the predetermined blacklist threshold, the corresponding source platform is blacklisted from the buyer system for a predetermined duration of time.

In various embodiments, for each source platform, if the determined score for each of a predetermined number of consecutive successive visitors is less than the predetermined blacklist threshold, the corresponding source platform is blacklisted from the buyer system for a predetermined duration of time.

In various embodiments, the method further comprises, for each source platform, determining the score for each successive visitor based on a binomial distribution analysis of the number of Web traffic visitors and the number of actions performed by at least some Web traffic visitors received from the corresponding source platform.

In some embodiments, the score for each successive visitor is determined based on an upper bound of a binomial proportion confidence interval of the binomial distribution analysis.

In some embodiments, the predetermined duration of time is count-based. In some other embodiments, the predetermined duration of time is based on one of a time-based parameter selected from the group consisting of minutes, hours, days, months and years.

In some embodiments, the number of actions performed by at least some Web traffic visitors received from the corresponding source platform is based on one or more action-based parameters selected from the group consisting of clicks, opt-ins, product purchases, product registrations and product downloads.

In another aspect, in at least one embodiment described herein, there is provided a system for optimizing Web traffic performance in real-time or batch mode, where the system comprises: one or more source platforms for providing Web traffic; and a buyer system comprising a memory, and a processor coupled to the memory, the buyer system being configured to host one or more websites and configured to purchase Web traffic from the one or more source platforms via a network, where the processor is configured to: record, in the memory, a predetermined blacklist threshold; receive a plurality of Web traffic visitors from a plurality of source platforms at a user interface module corresponding to the buyer system; record, in the memory, a number of Web traffic visitors received by the buyer system; for each source platform, determine a number of actions performed by at least some Web traffic visitors received from the corresponding source platform; for each successive visitor, determine a score based on the number of Web traffic visitors and the number of actions performed by at least some Web traffic visitors received from the corresponding source platform, the score being determined in real-time or batch mode; and for each successive visitor, if the determined score is greater than the predetermined blacklist threshold, accept the corresponding successive visitor by the buyer system.

In another embodiment, the processor is configured to perform the methods as defined above or other methods in accordance with the teachings herein.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is an example of a block diagram of an optimization platform;

FIG. 2 is an example of a block diagram of a Web traffic optimization system;

FIG. 3 is an example of a method for optimizing Web traffic performance in real-time;

FIG. 4 is another example of a method for optimizing Web traffic performance in real-time; and

FIG. 5 is an example of a table of data structure stored within a Web traffic optimization system.

The skilled person in the art will understand that the drawings, described below, are for illustration purposes only. The drawings are not intended to limit the scope of the applicants' teachings in anyway. Also, it will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF VARIOUS EMBODIMENTS

Various apparatuses or processes will be described below to provide an example of at least one embodiment of the claimed subject matter. No embodiment described below limits any claimed subject matter and any claimed subject matter may cover processes, apparatuses, devices or systems that differ from those described below. The claimed subject matter is not limited to apparatuses, devices, systems or processes having all of the features of any one apparatus, device, system or process described below or to features common to multiple or all of the apparatuses, devices, systems or processes described below. It is possible that an apparatus, device, system or process described below is not an embodiment of any claimed subject matter. Any subject matter that is disclosed in an apparatus, device, system or process described below that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

It should also be noted that the terms “coupled” or “coupling” as used herein can have several different meanings depending in the context in which the term is used. For example, the term coupling can have a mechanical or electrical connotation. For example, as used herein, the terms “coupled” or “coupling” can indicate that two elements or devices can be directly connected to one another or connected to one another through one or more intermediate elements or devices via an electrical element, electrical signal or a mechanical element such as but not limited to, a wire or a cable, for example, depending on the particular context.

It should be noted that terms of degree such as “substantially”, “about” and “approximately” as used herein mean a reasonable amount of deviation of the modified term such that the end result is not significantly changed. These terms of degree should be construed as including a deviation of the modified term if this deviation would not negate the meaning of the term it modifies.

Furthermore, the recitation of any numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation up to a certain amount of the number to which reference is being made if the end result is not significantly changed.

The various embodiments of the devices, systems and methods described herein may be implemented using a combination of hardware and software. These embodiments may be implemented in part using computer programs executing on programmable devices, each programmable device including at least one processor, an operating system, one or more data stores (including volatile memory or non-volatile memory or other data storage elements or a combination thereof), at least one communication interface and any other associated hardware and software that is necessary to implement the functionality of at least one of the embodiments described herein. For example, and without limitation, the computing device may be a server, a network appliance, an embedded device, a computer expansion module, a personal computer, a laptop, a personal data assistant, a cellular telephone, a smart-phone device, a tablet computer, a wireless device or any other computing device capable of being configured to carry out the methods described herein. The particular embodiment depends on the application of the computing device.

In some embodiments, the communication interface may be a network communication interface, a USB connection or another suitable connection as is known by those skilled in the art. In other embodiments, the communication interface may be a software communication interface, such as those for inter-process communication (IPC). In still other embodiments, there may be a combination of communication interfaces implemented as hardware, software, and a combination thereof.

In at least some of the embodiments described herein, program code may be applied to input data to perform at least some of the functions described herein and to generate output information. The output information may be applied to one or more output devices, for display or for further processing.

At least some of the embodiments described herein that use programs may be implemented in a high level procedural or object-oriented programming and/or scripting language or both. Accordingly, the program code may be written in C, Java, SQL or any other suitable programming language and may comprise modules or classes, as is known to those skilled in object-oriented programming. However, other programs may be implemented in assembly, machine language or firmware as needed. In either case, the language may be a compiled or interpreted language.

The computer programs may be stored on a storage media (e.g. a computer readable medium such as, but not limited to, ROM, magnetic disk, optical disc) or a device that is readable by a general or special purpose computing device. The program code, when read by the computing device, configures the computing device to operate in a new, specific and predefined manner in order to perform at least one of the methods described herein.

Furthermore, some of the programs associated with the system, processes and methods of the embodiments described herein are capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. In alternative embodiments the medium may be transitory in nature such as, but not limited to, wire-line transmissions, satellite transmissions, Internet transmissions (e.g. downloads), media, digital and analog signals, and the like. The computer useable instructions may also be in various formats, including compiled and non-compiled code.

The various embodiments disclosed herein generally relate to techniques for optimizing Web traffic performance. In particular, the various embodiments disclosed herein relate to optimizing performance of Web traffic, including all types of traffic received from one or more Web traffic bidding platforms. In some cases, the optimization of Web traffic is carried out in real-time. In some other cases, the optimization of Web traffic is carried out in batch mode. The batch mode optimization may be carried out in situations where one or more Web traffic bidding platforms do not lend themselves to real-time procurement.

Some non-limiting examples of Web traffic received from Web traffic bidding platforms include “redirect traffic”, “direct navigation traffic”, “domain traffic”, “type-in traffic”, “pay per click (PPC) traffic”, “pop-up (POP) traffic”, “organic traffic”, “search traffic” and “social traffic”.

In some cases, a rule-based blacklist is created to block under-performing Web traffic sources that may have misleading or fraudulent Internet traffic. However, in such cases, decision thresholds for blacklists are difficult to determine when traffic volumes per traffic source are low. Low long-tail traffic volumes may present a difficult trade-off between false positives and false negatives for buyers. Furthermore, rule-based blacklists cannot enable the buyer to assess Web traffic quality on a continuous basis in a real-time traffic bidding environment. Another problem with blacklists, i.e. blacklists that identify Internet traffic sources failing to deliver to buyers the actions, is that blacklists are often irreversible and unforgiving in nature and require considerable manual maintenance to fix.

In some cases, a Web traffic buyer can spend money on external third parties to evaluate the quality of large pools of Web traffic ex-post that it purchases from programmatic traffic sellers. After Web traffic has already been purchased, there are many ways to review its quality, but this is too late for the buyer who has already spent money purchasing the traffic for a dedicated period of time. For example, if there are multiple clicks coming from the same IP address, or surges of traffic coming from geographical areas outside of the buyer's target parameters, then these are indicia that the Web traffic purchased by the buyer is fraudulent. This discovery by the buyer, however, only comes after he or she has committed to the Web traffic, and accordingly, prevents the buyer from optimizing his or her advertising campaign prior to committing to the expenditure of monies on the Web traffic purchased from the vendor.

In some other cases, the buyer can employ entities, such as third-party vendors or industry associations etc., to conduct quality assurance on purchased Web traffic. For example, a buyer can rely on a quality assurance entity such as IAB Tech Lab that offers an initiative called ads.txt, where publishers can list on their websites all legitimate sellers of their ad inventory to help prevent the ad fraud practice known as “domain spoofing”.

However, this type of third-party quality assurance technique relies on the seller's assurances and maintenance and does not solve the long-tail traffic quality performance problem associated with Web traffic purchases. Another disadvantage of relying on seller's assurances or probabilistic traffic performance quality scores is that the Web traffic is already in use by the buyer. Furthermore, the algorithm used by the traffic vendor that informs such probabilistic quality scores is opaque to the buyer.

In addition to being unreliable and opaque to the buyer, vendors' categorical or probability blacklist algorithms are unhelpful if the advertiser's campaign is short-lived or ephemeral (e.g., one day, one hour or one week) as is often the case (e.g., leading up to a major sporting or political event such as an election etc.).

In some further cases, third-party ad fraud protection software may help monitor a company's Web traffic to identify real users versus bots and human fraud. However, such software does not enable the buyer to purchase quality high-performing traffic with efficiency in a proactive manner. This type of software helps assess traffic quality after it has already been deployed and is in use.

The various embodiments disclosed herein may provide the advantage of dramatically decreasing the ad buyer's likelihood of encountering digital ad fraud in a real-time bidding marketplace so that the buyer does not suffer the negative consequences of digital fraud, i.e. wasting money and time on fraudulent traffic or procuring digital ads fraught with click farms or bots.

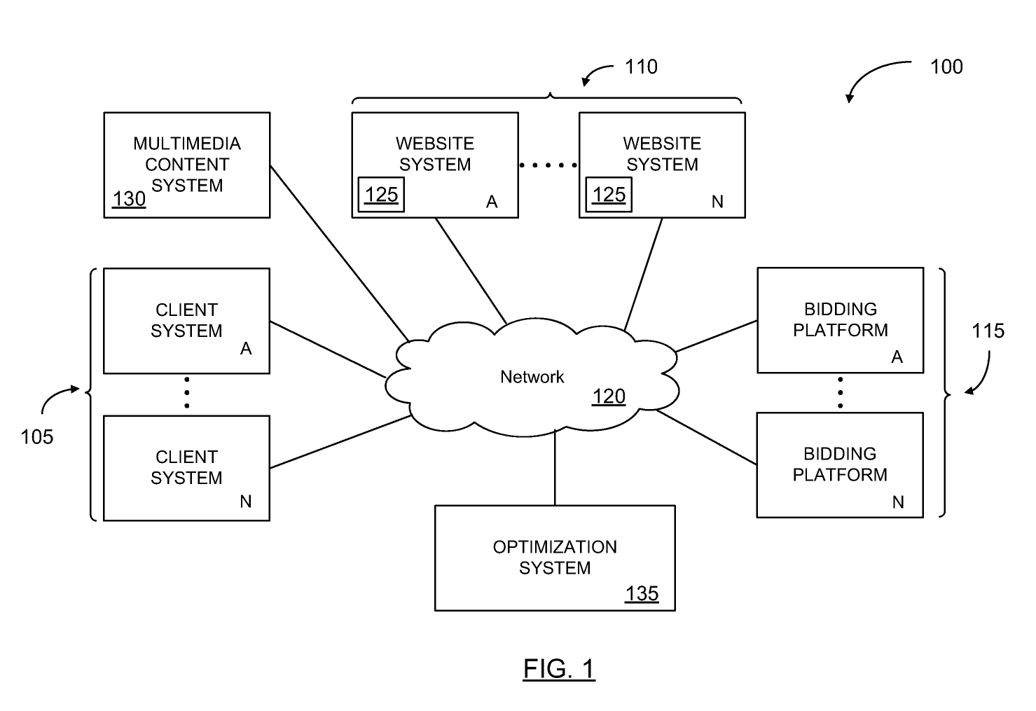

Reference is first made to FIG. 1 illustrating a block diagram of an optimization platform 100 in accordance with an example embodiment. The optimization platform 100 is provided as an example and there can be other embodiments of the platform 100 with different components or a different configuration of the components described herein. As illustrated, optimization platform 100 comprises one or more client system 105, one or more website systems 110, one or more bidding platforms 115, a multimedia content system 130, an optimization system 135 and network 120. In the illustrated embodiment, each of the one or more website systems 110 comprises corresponding one or more websites 125.

Client system 105 may be any networked computing device including a processor and memory, such as a personal computer, workstation, server, portable computer, mobile phone, personal digital assistant, laptop, smart phone, WAP phone, or a combination of these. Client system 105 typically includes one or more input devices, such as a keyboard, mouse, camera, touch screen and a microphone, and also includes one or more output devices such as a display screen and a speaker. Client system 105 has a network interface for connecting to network 120 in order to communicate with other components of the optimization platform 100.

Client system 105 is operated by a user using the one or more input devices. A user can operate the client system 105 to access one or more websites by typing respective one or more Web addresses on a Web browser. The user can also operate the client system 105 for other purposes, such as, for example, creating and accessing documents and emails, playing games, purchasing items, preparing spreadsheets, presentations, etc.

Network 120 may be any network(s) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX, ZigBee, LTE, CDMA, GSM, GPRS, Bluetooth), SS7 signaling network, fixed line, local area network, wide area network, and others, including any combination of these.

In the illustrated embodiment, the website system 110 is configured to manage and control the corresponding operating system, and related software, hardware and firmware, used to host a website 125. Each website system 110 has a network interface for connecting to network 120 in order to communicate with the client system 105, and other components of the optimization platform 100.

In some cases, the website system 110 is configured to generate some or all of its own content and provide that content on the respective website 125. In some other cases, the website system 110 is configured to receive some or all of its content and provide that content on the respective website 125. For example, the website system 110 may be coupled to a multimedia content server 130.

The multimedia content server 130 may be any server or server system equipped with a processor and a computer readable storage module that provides multimedia content, such as video content, audio content, animations, images, text or a combination etc., to the website system 110.

In various embodiments illustrated herein, one or more website systems 110 may be operated by a same individual, company or organization. The operator of such one or more website systems 110 is typically interested in increasing the number of visitors to the operator's websites to carry out operator-desired actions. Some examples of operator-desired actions include clicks, views, purchases, downloads, shares, likes etc.

In order to increase the traffic of Internet users to the operator's website system 110, operators may sometimes purchase Internet traffic on bidding platforms, such as bidding platforms 115 of the optimization platform 100. Such operators are interchangeably referred to herein as buyers. The buyers can specify certain demographic factors, such as age, gender, education, nationality etc., at the bidding platforms 115 to purchase desired Internet traffic. The buyers can also specify other factors, such as keywords, location(s), devices and user profiles (e.g. interests, favorites etc.) and other such factors, at the bidding platforms 115 to purchase desired Internet traffic.

In the illustrated embodiment, the optimization platform 100 also comprises one or more bidding platforms 115. Bidding platform 115 is a networked computing device or server including a processor and memory. Bidding platform 115 provides a marketplace for buyers operating website system 110 for trading advertising inventory, including purchasing Web visitors. A buyer may purchase Web visitors by specifying the demographic or other desired factors at the bidding platform 115 in exchange for a consideration, e.g. money, services, etc.

In some cases, a buyer may approach multiple bidding platforms 115 to purchase Internet traffic. However, while doing so may increase the Web traffic being received from a pool of distinct traffic sources, it may not yield the optimum actions on the buyer's websites. This may be because, in some cases, the Web traffic sold to the buyer from one or more bidding platforms 115 may not meet the buyer's requirements, such as demographic requirements, location requirements etc. Instead, the Internet traffic sold to the buyer may be fraudulently staffed with mismatched demographics, and misleading quality. As a result, the cost of under-performing Web traffic, i.e. traffic that does not yield the actions, becomes significant since the buyer has already spent money and devoted human resources to purchase and plan the uses and frequency of actions of the traffic, but the Web traffic did not result in desired number of actions.

As illustrated in FIG. 1, the optimization platform 100 comprises a Web traffic optimization system 135 (interchangeably referred to herein as ‘the optimization system’). The optimization system 135 may be any networked computing device including a processor and memory, and may be configured to optimize the Web traffic to the dynamic website system 110. In some cases, the optimization system 135 may be physically integrated with the dynamic website system 110 and accordingly, located at the same location. In some other cases, the optimization system 135 may be located remotely from the dynamic website system 110, as shown in FIG. 1.

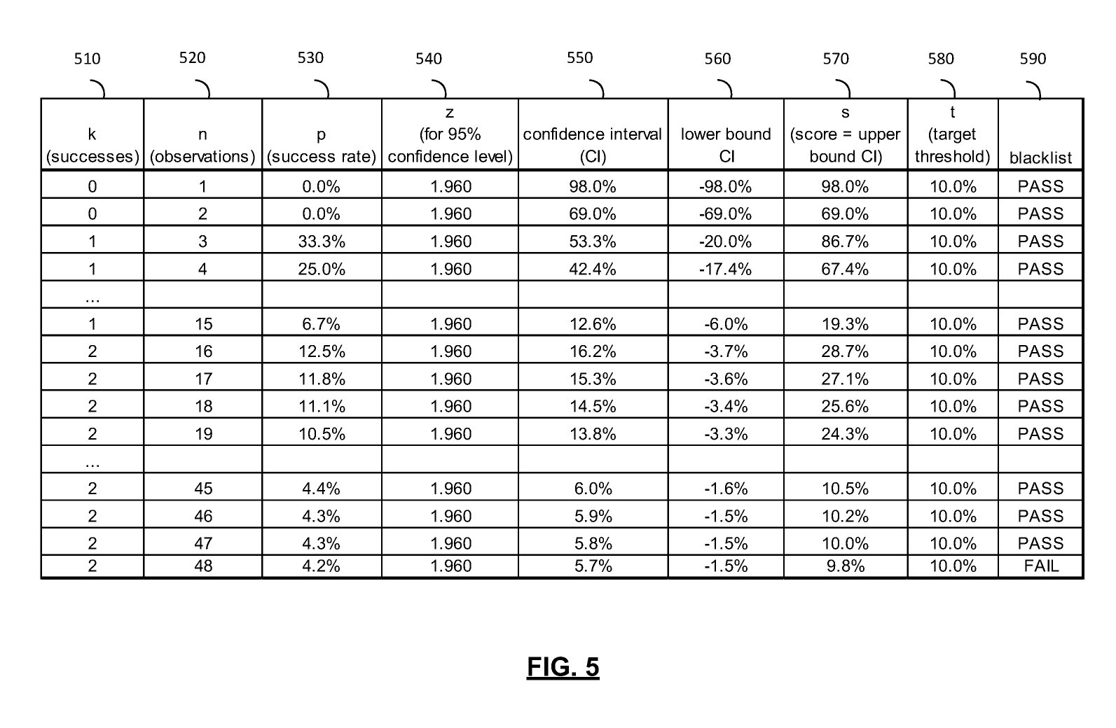

Reference is simultaneously made to FIG. 5, which illustrates a table 500 showing an example of a data structure stored within an optimization system, such as the optimization system 135 of FIG. 1.

In at least one embodiment, the optimization system 135 provides the Web traffic buyer with real-time decision-making insights for real-time decisions over which Web traffic to buy and/or abandon, and which traffic to keep for the purposes of any desired action of the Web traffic, such as lead generation, niche-based or broad-based product or service advertising etc. In some other cases, the optimization system 135 may optimize the Web traffic in batch mode.

The Web traffic optimization system 135 is configured to keep a count of visitors (also referred to as sample size, n) to the website system 110 operated by an operator. The Web traffic optimization system 135 is also configured to keep a count of actions (also referred to as success observations, k) performed by the visitors at the website system 110.

Reference is briefly made to FIG. 5, which shows a sample size (or observations), n, column 520 and a successful observation, k, column 510. The sample size column 520 keeps track of the visitors to the optimization system 135, whereas the successful observation column 510 keeps track of those visitors that perform successful actions at the optimization system 135.

The Web traffic optimization system 135 is configured to estimate the probability of success (p) for actions at the website system 110. In some cases, the Web traffic optimization system 135 is configured to apply a binomial distribution to estimate the probability of success for actions. For example, the Web traffic optimization system 135 is configured to determine a binomial proportion confidence interval for each successive visitor. The Web traffic optimization system 135 may be configured to determine a binomial proportion confidence interval for each successive visitor using any binomial distribution approach, such as, for example, asymptotic normal approximation, Agresti-Coull interval, Clopper-Pearson interval based on Beta distribution, Wilson Score interval, Jeffreys Bayesian Interval etc. In such cases, as sample size increases, the range of the estimate for p decreases.

Table 500 of FIG. 5 shows a success rate column, p, 530, which relates to the probability of successful actions by each successive visitor. In the illustrated embodiment of FIG. 5, column 530 relates to the probability of successes in a Bernoulli trial.

Also shown in table 500 is a z-column 540, which shows that for a 95 percent confidence level, the value of ‘z’ is 1.96. Column 550 of table 500 shows the binomial proportion confidence interval calculated for each successive visitor. The confidence interval may be calculated based on any of the numerous binomial proportion approaches listed above. Column 560 shows the lower bound of the confidence interval, and column 570 shows the upper bound of the confidence interval.

In some cases, the Web traffic optimization system 135 is configured to use an upper bound of the binomial proportion confidence interval to score (s=score) the Web traffic source in real-time to reduce the rate of false negatives.

In some embodiments, the Web traffic optimization system 135 is configured to set a predetermined success rate as a minimum score threshold (threshold=t). The predetermined success rate may be based on a nominally acceptable success rate. In such embodiments, the Web traffic optimization system 135 is configured to determine if the score, s, of the Web traffic source is greater than the threshold, t, and if so, corresponding traffic sources are allowed to pass through to provide Internet traffic to the website system 110. The Web traffic optimization system 135 may be configured to blacklist sources if the score, s, of the Web traffic source is less than the threshold, t.

This is shown in table 500 of FIG. 5, where column 580 relates to the predetermined threshold, t, and column 590 shows the results of comparison between the values in column 570, relating to score ‘s’, and column 580, relating to the predetermined threshold ‘t’. FIG. 5 also illustrates how with each successive observation the confidence interval of column 550 shortens and the score or the upper bound of the confidence interval of column 570 eventually drops below the target threshold of column 580.

In various embodiments disclosed herein, the Web traffic optimization system 135 comprises a training system, which allows traffic sources with small sample sizes to pass through if the corresponding score, s, is greater than the threshold, t. As the training sample size increases, the confidence interval of the Web traffic optimization system 135 narrows and estimate of the probability of success, p, becomes more precise. In other words, as sample size increases, the Web traffic optimization system 135 becomes more confident in taking the score, s, which is the upper bound of probability of success, p, as representing the true success rate. In such embodiments, the Web traffic optimization system 135 blacklists sources that do not meet a minimum success rate, t (i.e. when score <threshold). This approach may have an advantage of softening the reject rate compared to conventional binary blacklist criteria-based scoring/threshold methods that are typically less forgiving.

In various embodiments disclosed herein, the Web traffic optimization system 135 comprises a short-term memory to create a dynamic and adaptive blacklist based on the teachings disclosed herein. In some cases, the Web traffic optimization system 135 is configured to implement data buffers as time-based windows. A data buffer can be a FIFO (first-in, first-out) storage system that will only retain the most recent data points. In some other cases, the Web traffic optimization system 135 is configured to implement data buffers as sample-sized windows. The window size can be count-based (e.g. last 1,000 samples) or time-based (e.g. samples for the last 10 days).

The short-term memory implementation of the Web traffic optimization system 135 may provide the advantage of enabling low-scoring traffic sources to improve their traffic quality scores. For any operator, the history of sample size (n) and success observations (k) is limited to the most recently collected data by the operator, and therefore, traffic sources are given an opportunity under this implementation to improve their quality score without manual intervention or maintenance.

In some cases, the Web traffic optimization system 135 is configured to optimize the Internet traffic by controlling or tuning rule-based parameters, such as controlling the confidence level to calculate the upper bound of the binomial proportion confidence interval (p). In such cases, a higher confidence level will require larger sample sizes (n) to meet target thresholds (t).

In some other cases, the Web traffic optimization system 135 is configured to optimize the Internet traffic by controlling another rule-based parameter, such as controlling the time window or sample size window to control the short-term memory for blacklisted sources. This can control the responsiveness of the blacklist of traffic sources to score improvements and degradation in the quality of all traffic sources.

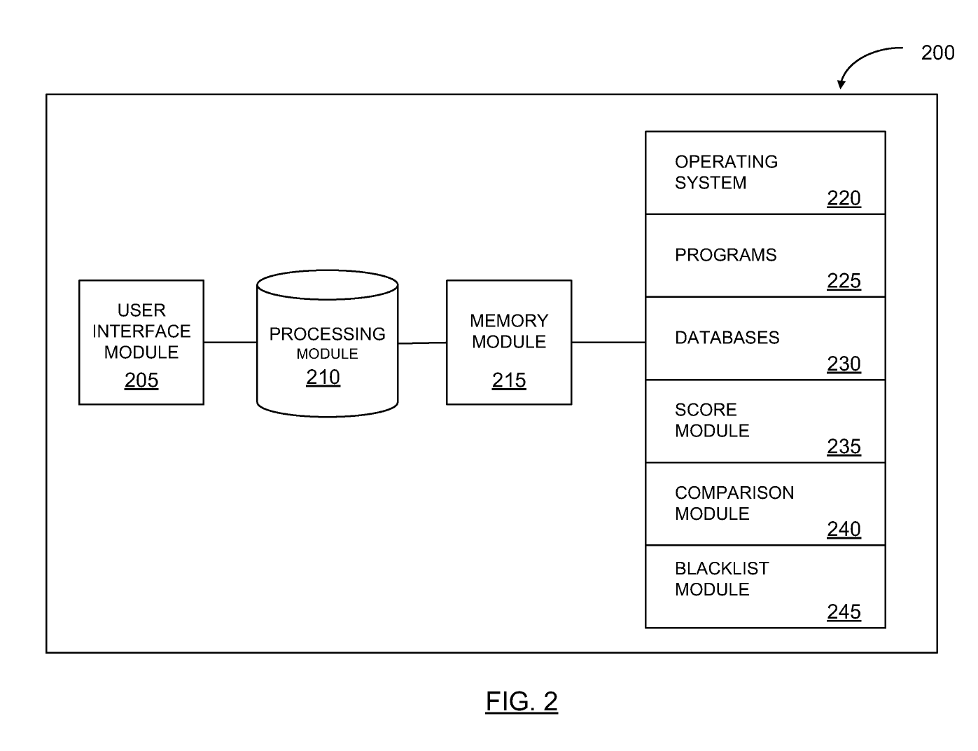

In some further cases, the Web traffic optimization system 135 is configured to determine the score of the traffic source based on more than one successful action/feature. This may provide flexibility to website system operators to optimize their systems for actions to multiple targets. In other words, operators can optimize their systems to target more than just one action (e.g. click-through rates, referred to as “CTRs”, on different landing pages). Under this system, the operators can also combine one action with another action (e.g. opt-ins, app purchases, product downloads can be combined), and thus overall performance of all actions can be improved. The functionalities and structure of the Web traffic optimization system 135 are discussed in further detail below with reference to FIG. 2.

FIG. 2 illustrates a block diagram 200 of a Web traffic optimization system, such as the Web traffic optimization system 135 of FIG. 1. The system 200 is provided as an example and there can be other embodiments of the system 200 with different components or a different configuration of the components described herein. System 200 comprises an interface module 205, a processing module 210 and a memory module 215. The memory module 215 comprises software code for implementing an operating system 220, various programs 225, one or more databases 230, a score module 235, a comparison module 240 and a blacklist module 245.

The interface module 205 can be any interface that allows the Web traffic optimization system 200 to communicate with other devices or computers of an optimization system, such as client systems 105 and website system 110 of FIG. 1. In various cases, the interface module 205 includes network or network components capable of carrying data including the Internet, Ethernet, plain old telephone service (POTS) line, Firewire modem, public switch telephone network (PSTN), integrated services digital network (ISDN), digital subscriber line (DSL), coaxial cable, fiber optics, satellite, mobile, wireless (e.g. Wi-Fi, WiMAX, radio communicating utilizing CDMA, GSM, GPRS or Bluetooth protocol according to standards such as IEEE 802.11a, 802.11b, 802.11g, or 802.11n), SS7 signaling network, fixed line, local area network (LAN), wide area network (WAN), a direct point-to-point connection, mobile data networks (e.g., Universal Mobile Telecommunications System (UMTS), 3GPP Long-Term Evolution Advanced (LTE Advanced), Worldwide Interoperability for Microwave Access (WiMAX), etc.), and others, including any combination of these. In some other cases, the interface module 205 includes at least one of a serial port, a parallel port or a USB port that provides USB connectivity.

The processing module 210 controls the operation of the Web traffic optimization system 200. The processing module 210 can be any suitable processor, controller or digital signal processor that can provide sufficient processing power processor depending on the configuration, purposes and requirements of the Web traffic optimization system 200. For example, the processing module 210 may be a high-performance general processor. In alternative embodiments, the processing module 210 can include more than one processor with each processor being configured to perform different dedicated tasks. In alternative embodiments, it may be possible to use specialized hardware to provide some of the functions provided by the processing module 210.

The memory module 215 can include RAM, ROM, one or more hard drives, one or more flash drives or some other suitable data storage elements such as disk drives, etc. The memory module 215 is used to store an operating system 220 and programs 225, where the operating system 220 provides various basic operational processes for the Web traffic optimization system 200 and the programs 225 include various user programs so that a user can interact with the Web traffic optimization system 200 to perform various functions such as, but not limited to, keeping count of visitors (n) to an operator's website system, keeping count of actions (k) at operator's website system, etc.

The score module 235 is configured to interact with at least one of the memory module 215 and the databases 230, and is configured to calculate a score corresponding to the traffic source to the operator's website system. The score module 235 can be determined based on binomial distribution to estimate the probability of success (p) for actions. In some cases, the score module 235 can determine the binomial proportion confidence interval for each successive visitor. In addition, the score module 235 is configured to determine the score of each Web traffic source in real time or batch mode based on an upper bound of the binomial proportion confidence interval.

The comparison module 240 is configured to interact with at least one of the memory module 215 and the databases 230, and is configured to determine whether a Web traffic source should be blacklisted or not. The comparison module 240 is configured to compare the score of each Web traffic source, as determined by the score module 235, to a predetermined threshold, t. The comparison module 240 is configured to determine if the score of a Web traffic source exceeds the predetermined threshold, or not. If the score of a Web traffic source exceeds the predetermined threshold, the corresponding Web traffic source is allowed to provide Internet traffic to the operator. If the score of a Web traffic source is less than the predetermined threshold, the corresponding Web traffic source is blacklisted and managed by the blacklist module 245.

The blacklist module 245 is configured to interact with at least one of the memory module 215 and the databases 230, and is configured to manage the list of blacklisted Internet traffic sources. The blacklist module 245 is configured to manage a dynamic and adaptive list of blacklist Web traffic sources that is refreshed on a short-term basis. In some cases, the blacklist module 245 can implement a short-term memory by using data buffers as time-based windows and/or sample-sized windows, as discussed above, to maintain a dynamic list of blacklist sources.

The various embodiments disclosed herein may provide the advantage of allowing advertisers or buyers an opportunity to bid on low volume but high-valued keywords for their advertising or lead-generation needs. This may help the buyers to work within limited budgets economically and minimize overspending on expensive keyword domains that may have a low probability of yielding acceptable return-on-investment.

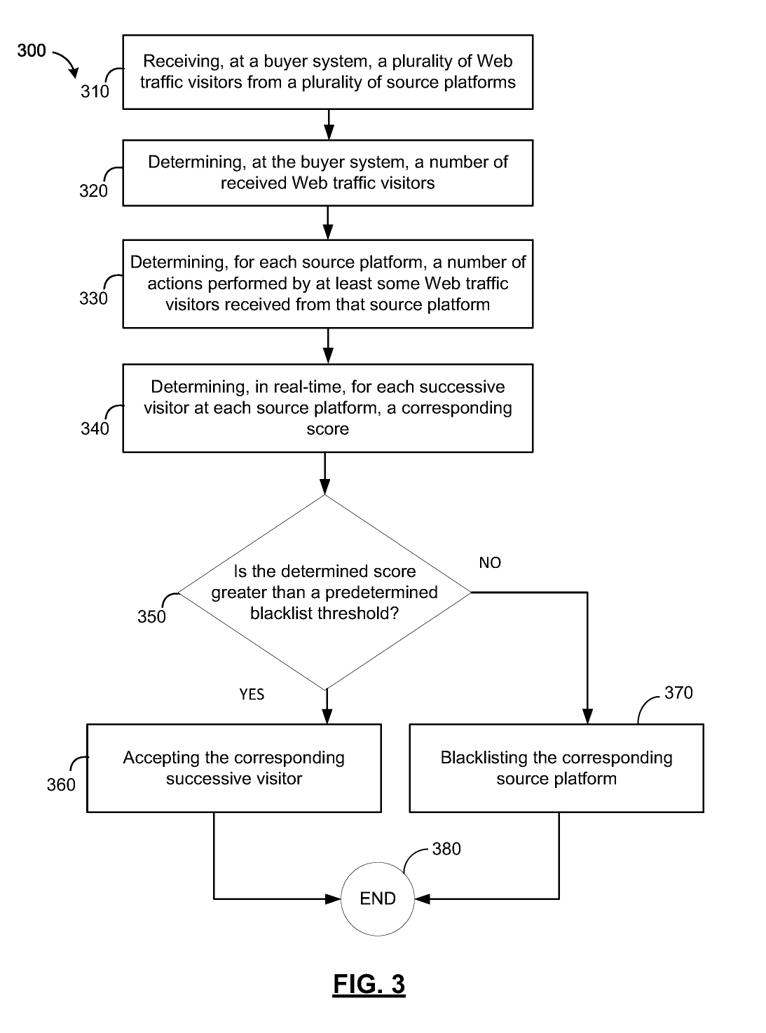

Reference is next made to FIG. 3, which illustrates an example embodiment of a method 300 for optimizing Web traffic performance. The method 300 can be performed by a buyer system, where the buyer system refers to any optimization system, such as the optimization system 135 of FIG. 1 or the optimization system 200 of FIG. 2 in collaboration with a website system, such as the website system 110 of FIG. 1. The buyer system comprises a memory, such as a memory module 215 of FIG. 2, and a processor, such as a processing module 210 of FIG. 2, coupled to the memory.

The method 300 begins at 310 where the buyer system receives a plurality of Web traffic visitors from a plurality of source platforms, such as bidding platform 115 of FIG. 1. The buyer system hosts one or more websites, such as websites 125 of FIG. 1, and purchases Web traffic from one or more source platforms via a network, such as network 120 of FIG. 1. The Web traffic visitors may be received at a user interface module, such as module 205 of FIG. 2, corresponding to the buyer system.

At 320, the processor at the buyer system is configured to determine a number of received Web traffic visitors. The number of received Web traffic visitors is synonymous to a sample size, n, corresponding to the buyer system. The number of received Web traffic visitors may be stored in the memory at the buyer system.

At 330, the processor is configured to determine, for each source platform, a number of actions performed by at least some Web traffic visitors received from that source platform. The actions may be any buyer-desired action parameter, such as clicks, opt-ins, product purchases, product registrations, product likes, product downloads etc. In other words, if a Web traffic visitor carries out a desired action on the buyer's website, the action is considered successful and the action count (or the number of actions) is incremented.

At 340, the processor is further configured to determine, for each successive visitor at each source platform, a corresponding score in real-time. In some other cases, the score may be determined in batch mode. The score is based on the total number of Web traffic visitors and the number of actions performed by at least some Web traffic visitors received from the corresponding source platform. The score may be based on a binomial distribution analysis of the number of Web traffic visitors and the number of actions performed by at least some Web traffic visitors received from the corresponding source platform. In some cases, the score may be determined based on an upper bound of a binomial proportion confidence interval of the binomial distribution analysis.

At 350, the processor is configured to determine, for each successive visitor at each source platform, if the determined score is greater than a predetermined blacklist threshold. The predetermined blacklist threshold may be pre-stored at a memory module at the buyer system, and may be changeable by an operator of the buyer system. If the determined score is greater than the predetermined blacklist threshold, at 360, the processor is configured to accept the corresponding successive visitor.

However, if the determined score is less than or equal to the predetermined blacklist threshold, at 370, the processor is configured to blacklist the corresponding source platform from the buyer system for a predetermined duration of time. In some cases, the predetermined duration of time is count-based. For example, in such cases, the most recent 100, 1000 or any predetermined number of visitors who do not have a score greater than the predetermined blacklist threshold are blacklisted. In some other cases, the predetermined duration of time is based on a time-based parameter, such as, minutes, hours, days, months and years etc. In such cases, a blacklisted visitor may be blacklisted only for a few days or a few months, etc. The method ends at 380.

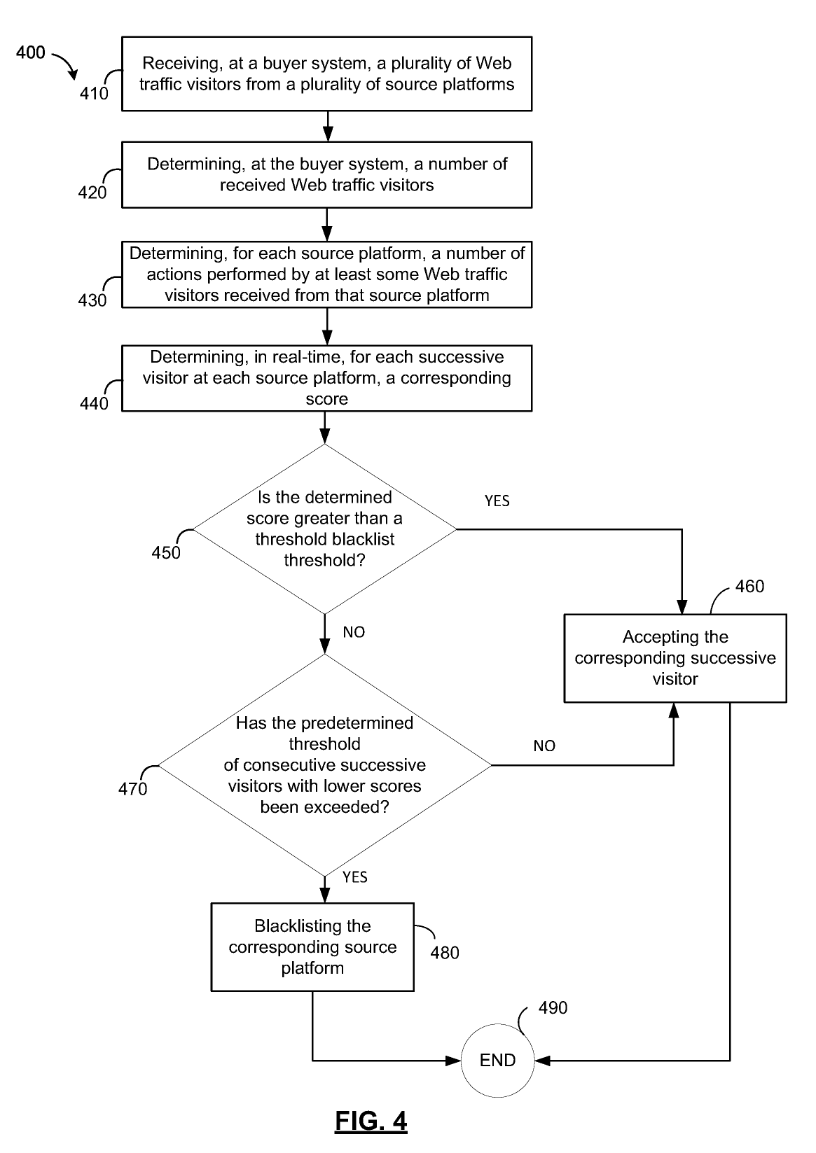

Reference is next made to FIG. 4, which illustrates another example embodiment of a method 400 for optimizing Web traffic performance. The method 400 can be performed by a buyer system, where the buyer system refers to any optimization system in collaboration with a website system, as discussed above. The buyer system comprises a memory and a processor coupled to the memory.

Method 400 is analogous to method 300, and steps 410, 420, 430, 440, 450 and 460 are analogous to steps 310, 320, 330, 340, 350 and 360 of method 300 of FIG. 3. However, the method 400 differs from method 300 when at 450, the processor is configured to determine, for each successive visitor at each source platform, if the determined score is greater than the predetermined blacklist threshold. If the determined score is greater than the predetermined blacklist threshold, the processor is configured to accept the corresponding successive visitor at 460, analogous to step 360 of FIG. 3.

However, if the determined score is less than or equal to the predetermined blacklist threshold, the method proceeds to 470. At 470, the processor is configured to determine if a predetermined threshold of consecutive successive visitors with respective scores less than the predetermined blacklist threshold has been exceeded. In other words, the processor first determines the number of successive visitors, consecutively, that fail to have a score greater than the predetermined blacklist threshold. Next, the processor compares the count of such successive visitors to a predetermined threshold. If the predetermined threshold is determined to have been exceeded, the method proceeds to 480 where the processor is configured to blacklist the corresponding source platform for a predetermined duration of time.

However, if the predetermined threshold is not determined to have been exceeded, the method returns to 460, where the processor is configured to accept the successive visitor. The method ends at 490.

This is further explained by way of an example, where a buyer in the healthcare sector wishing to bid on a high-value keyword like ‘melanoma’ could pay over $300 USD per visitor when buying from a traffic aggregator platform, such as platform 115 of FIG. 1. By utilizing the various embodiments disclosed herein, and especially the embodiment of method 400, the buyer's loss can be limited per non-converting domain if the predetermined threshold of non-converting visitors is set, for example, low enough to limit the number to 3 to 5 samples.

In another example, if the incoming traffic to the buyer has a nominal click-through rate of 3 percent but suddenly a fraudulent source appears with seemingly high volume (e.g. over 5,000 visitors per hour with no clicks), the various embodiments disclosed herein, and especially the embodiment of method 400, can help in blacklisting the fraudulent source after five clicks instead of compelling the advertiser to spend, for example, a significant cost per hour with a zero click-through rate.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments.

1. A method for optimizing Web traffic performance, where a buyer system hosts one or more websites and purchases Web traffic from one or more source platforms via a network, the method comprising:
storing a predetermined blacklist threshold in a memory corresponding to the buyer system;
receiving a plurality of Web traffic visitors from a plurality of source platforms at a user interface module corresponding to the buyer system;
recording, in the memory, a number of Web traffic visitors received by the buyer system;
for each source platform:
determining, at a processor corresponding to the buyer system, a number of actions performed by at least some Web traffic visitors received from the corresponding source platform;
for each successive visitor, determining, at the processor, a score based on the number of Web traffic visitors and the number of actions performed by at least some Web traffic visitors received from the corresponding source platform, the score being determined in real-time or batch mode; and
for each successive visitor, if the determined score is greater than the predetermined blacklist threshold, accepting the corresponding successive visitor by the buyer system.

2. The method of claim 1, wherein for each successive visitor, if the determined score is less than the predetermined blacklist threshold, the corresponding source platform is blacklisted from the buyer system for a predetermined duration of time.

3. The method of claim 1, wherein for each source platform, if the determined score for each of a predetermined number of consecutive successive visitors is less than the predetermined blacklist threshold, the corresponding source platform is blacklisted from the buyer system for a predetermined duration of time.

4. The method of claim 1, further comprising, for each source platform, determining the score for each successive visitor based on a binomial distribution analysis of the number of Web traffic visitors and the number of actions performed by at least some Web traffic visitors received from the corresponding source platform.

5. The method of claim 4, wherein the score for each successive visitor is determined based on an upper bound of a binomial proportion confidence interval of the binomial distribution analysis.

6. The method of claim 2, wherein the predetermined duration of time is count-based.

7. The method of claim 2, wherein the predetermined duration of time is based on one of a time-based parameter selected from the group consisting of minutes, hours, days, months and years.

8. The method of claim 3, wherein the predetermined duration of time is count-based.

9. The method of claim 3, wherein the predetermined duration of time is based on one or more time-based parameters selected from the group consisting of minutes, hours, days, months and years.

10. The method of claim 1, wherein the number of actions performed by at least some Web traffic visitors received from the corresponding source platform is based on one or more action-based parameters selected from the group consisting of clicks, opt-ins, product purchases, product registrations and product downloads.

11. A system for optimizing Web traffic performance, the system comprising:
one or more source platforms for providing Web traffic; and
a buyer system comprising a memory, and a processor coupled to the memory, the buyer system being configured to host one or more websites and configured to purchase Web traffic from the one or more source platforms via a network, wherein the processor is configured to:
record, in the memory, a predetermined blacklist threshold;
receive a plurality of Web traffic visitors from a plurality of source platforms at a user interface module corresponding to the buyer system;
record, in the memory, a number of Web traffic visitors received by the buyer system;
for each source platform:
determine a number of actions performed by at least some Web traffic visitors received from the corresponding source platform;
for each successive visitor, determine a score based on the number of Web traffic visitors and the number of actions performed by at least some Web traffic visitors received from the corresponding source platform, the score being determined in real-time or batch mode; and
for each successive visitor, if the determined score is greater than the predetermined blacklist threshold, accept the corresponding successive visitor by the buyer system.

12. The system of claim 11, wherein for each successive visitor, if the determined score is less than the predetermined blacklist threshold, the processor is configured to blacklist the corresponding source platform from the buyer system for a predetermined duration of time.

13. The system of claim 11, wherein for each source platform, if the determined score for each of a predetermined number of consecutive successive visitors is less than the predetermined blacklist threshold, the processor is configured to blacklist the corresponding source platform from the buyer system for a predetermined duration of time.

14. The system of claim 11, wherein for each source platform, the processor is configured to determine the score for each successive visitor based on a binomial distribution analysis of the number of Web traffic visitors and the number of actions performed by at least some Web traffic visitors received from the corresponding source platform.

15. The system of claim 14, wherein the processor is configured to determine the score for each successive visitor based on an upper bound of a binomial proportion confidence interval of the binomial distribution analysis.

16. The system of claim 12, wherein the predetermined duration of time is count-based.

17. The system of claim 12, wherein the predetermined duration of time is based on one of a time-based parameter selected from the group consisting of minutes, hours, days, months and years.

18. The system of claim 13, wherein the predetermined duration of time is count-based.

19. The system of claim 13, wherein the predetermined duration of time is based on one or more time-based parameters selected from the group consisting of minutes, hours, days, months and years.

20. The system of claim 11, wherein the number of actions performed by at least some Web traffic visitors received from the corresponding source platform is based on one or more action-based parameters selected from the group consisting of clicks, opt-ins, product purchases, product registrations and product downloads.
